(19) United States
(12) Patent Application Publication
(10) Pub. No.: US 2013/0232516 A1
(43) Pub. Date: Sep. 5, 2013

(54) Method And Apparatus for Collection and Analysis of Real-Time Audience Feedback

(71) Applicant: David S. PAULL, Portland, OR (US)

(72) Inventor: David S. PAULL, Portland, OR (US)

(21) Appl. No.: 13/410,101

(22) Filed: Mar. 1, 2012

(51) Int. Cl. H04N 21/24

(52) U.S. Cl. 725/13

(57) ABSTRACT

A viewer sentiment collection and analysis system provides a user interface to collect information during the performance or display of a media program. Sentiment indications are collected periodically, during the program, and recorded with information to permit the instantaneous indications to be associated with particular parts of the program.

### CONTINUITY AND CLAIM OF PRIORITY

This is an original U.S. patent application.

### FIELD

The invention relates to methods for evaluating media programs. More specifically, the invention relates to methods for acquiring detailed feedback from audience members while they are viewing a program online. Programs may be, for example, advertisements, promotional videos, movie trailers and live video streams.

### BACKGROUND

Successful entertainers (e.g., actors, comedians and musicians) often use audience feedback cues from live performances to adjust their work so that it provokes a more-enthusiastic response. When works are not performed live, it can be more difficult to obtain feedback about what is effective and what leaves audiences flat.

Some artists are indifferent (or profess indifference) to audience appreciation, but viewer appeal is important in many circumstances, notwithstanding that it is often difficult to measure. Gross metrics such as number of tickets sold (for movies), albums sold (for music), and statistical estimations of viewership (for television programs) allow comparisons between works (e.g., movie A is better [in some sense] than movie B because more people went to see it), but they are less useful for figuring out what, exactly, appealed to the audience.

Movie production ventures now routinely conduct test screenings: an unfinished movie is shown to an audience, whose feedback is solicited and used to adjust the editing or even the plot of the movie. Similarly, television programs (and especially broadcast advertisements) are tested by airing different versions, at different times and in different places; with careful data collection and analysis to select the most popular and/or effective version.

Nevertheless, there is still unsatisfied demand for more detailed, more accurate, and simply more audience feedback data to help guide the creation of new entertainment programming. Systems and methods to acquire and analyze this data may be of significant value to media producers.

### SUMMARY

Embodiments of the invention augment online or Internet media players to collect time-varying sentiment data from a viewer while he watches and/or listens to a program. The data are recorded and may be analyzed to learn what program features elicit a desired response from viewers, or to identify other programs that may appeal to the viewer.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows people and entities involved in the operation of an embodiment of the invention.

FIG. 2 outlines a basic method of an embodiment of the invention.

FIGS. 3A and 3B show computer display screens produced by an embodiment of the invention.

### DETAILED DESCRIPTION

Embodiments of the invention collect real-time data from a user, while he watches (or listens to) a media program. A preferred implementation works with an ordinary web browser and media player to collect sentiment information while the program plays. Data may be aggregated and used by content producers to improve future programs, and/or by a system that helps the user find additional programming that may be of interest to him.

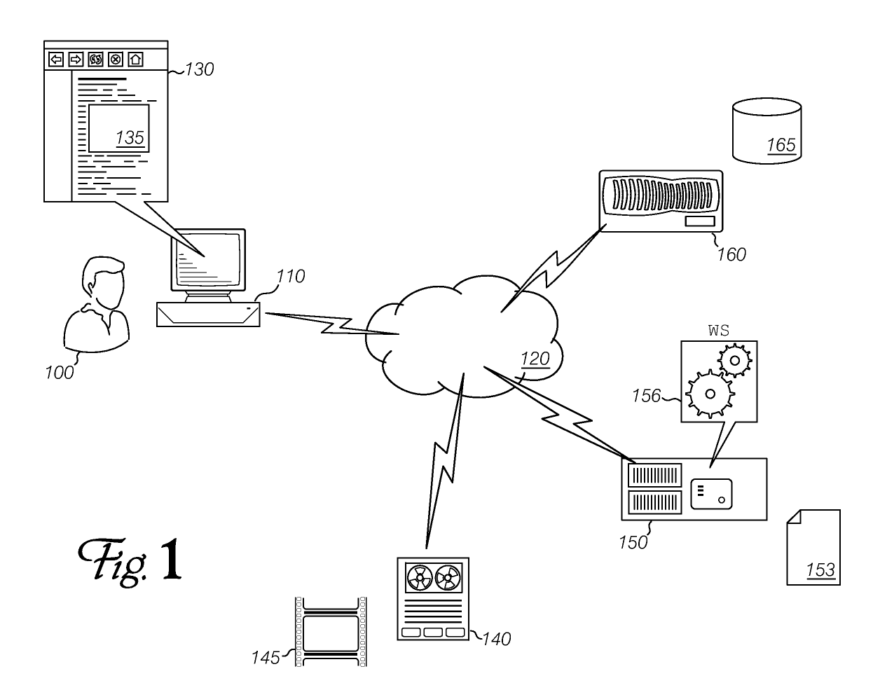

FIG. 1 shows a general environment where an embodiment of the invention may be deployed. A user 100 at his personal computer 110 uses software such as a web browser to retrieve and display resources available from other computers through a distributed data communication network 120 such as the Internet. The web browser constructs a display 130 containing remote content, and formatted according to rules or guidelines. The content may come from different remote sites 140, 150, 160; or all from a single remote computer. In this sample environment, a Hypertext Markup Language (“HTML”) document 153 is retrieved from a web server 156 executing at computer 150. This document provides basic formatting information for the web browser at personal computer 110, such as background color, font size and selection, and so on; and also specifies other remote servers from which additional content should be retrieved. For example, HTML document 153 may direct computer 110 to retrieve a multimedia stream 145 from server 140 and incorporate the video at location 135 within the web browser's display 130.

When an embodiment of the invention is in use, the web browser also interacts with server 160 as detailed below, to collect real-time information from user 100 as he watches multimedia stream 145, and to store the information in a database 165 for subsequent application. It should be understood that the various servers 140, 150 and 160, which offer different resources and play different roles in an embodiment, could all be co-located on a single server; or the resources and functions could be further subdivided among an even larger number of server computers. In addition, although the Internet provides an efficient and flexible communication infrastructure, the computers and systems participating in an embodiment need not all interact via the Transmission Control Protocol/Internet Protocol (“TCP/IP”) communication method that underlies most Internet-supported interactions. For example, some of the media content could be delivered via a radio signal or a cable-television system.

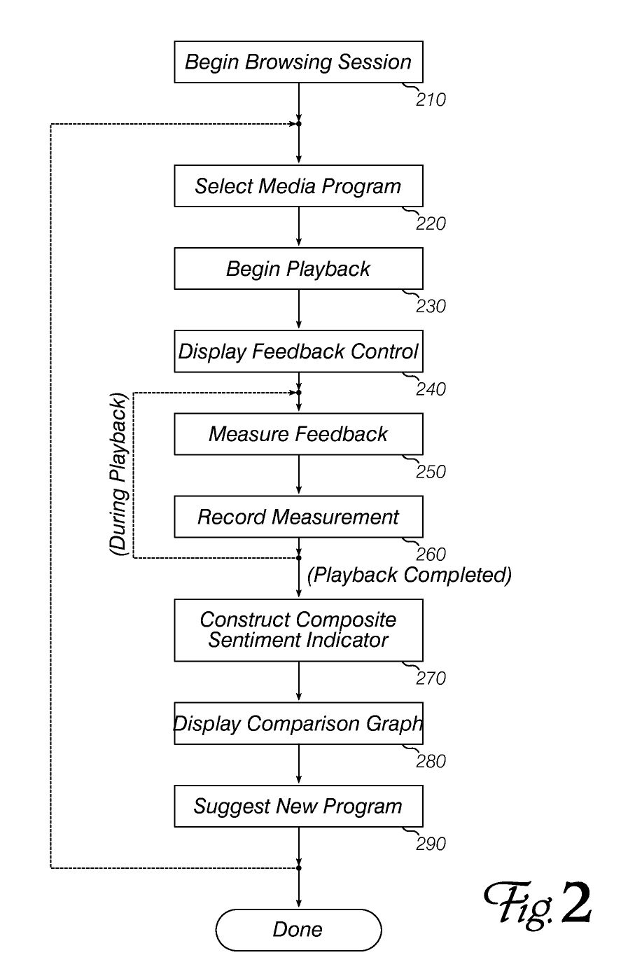

Within an environment generally like the example shown in FIG. 1, an embodiment operates as outlined in the flow chart of FIG. 2. The process starts when a user begins a web browsing session (210), for example, by starting a program such as Firefox, Chrome, Safari, Opera or Internet Explorer. Eventually, the user may select a media program to view (220) and commence playback (230) by activating a “Play” control. An embodiment of the invention arranges for a feedback control to be displayed (240) (or otherwise provides a mechanism for the user to indicate his level of interest). At intervals during playback, the embodiment measures the feedback control (250) and records the measurement (260). After playback is completed (or if the user interrupts or terminates the playback), an embodiment may construct a composite sentiment indicator (270) from some or all previously-recorded feedback measurements taken while other viewers watched the same program, and may display a comparison graph to the user (280). The user's recorded feedback measurements may also be used to suggest a new program that the user may find interesting (290). If so, the user may select the program (220) and the process begins again.

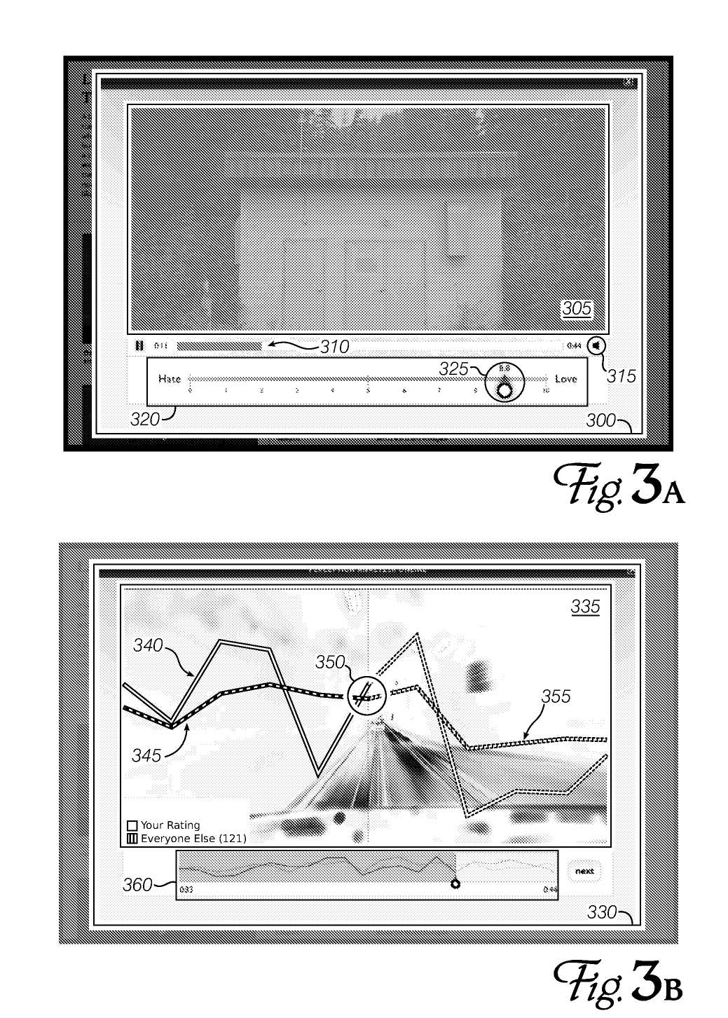

FIG. 3A shows an example screen display produced by an embodiment. A window 300 displays a media program 305. The window may include conventional controls or indicators such as an elapsed-time meter 310 or a volume control 315. An embodiment will also include a mechanism for the viewer to provide real-time feedback about some aspect of the program. In the display shown here, a horizontal slide control 320 appears beneath the playback window, and a slider 325 may be adjusted left or right to indicate (in this example) “Hate” or “Love” (i.e., the viewer's enjoyment or interest level). Other sorts of feedback controls, such as a vertical slider or “Like” and “Dislike” buttons, may be provided as well. In some embodiments, the feedback control may not normally display any visual indication—the user may simply turn a physical control such as a dial or mouse scroll wheel one way or another to indicate his current sentiment.

The viewer operates the slider or other control to indicate his level of interest in or enjoyment of the program at that point in the program. (Traditionally, rating systems collect only a single rating, or ratings on a few metrics, at the end of the program.) An embodiment collects time-stamped data during playback, so it can provide more insight into which portions of the program appeal most to viewers.

One challenge in collecting real time information during program playback is distinguishing between active user engagement (where the feedback control position may be indicative of viewer sentiment) and user disinterest or neglect (e.g., when the viewer may have set the feedback control, but is no longer watching the program, or at least is not affirmatively providing feedback). An embodiment of the invention may be able to improve feedback data collection by implementing an automatically-changing or -decaying feedback control. For example, in a sliding control, the slider position automatically returns to zero over a decay period, unless the user actively adjusts the position of the slider.

An alternative user interface may allow better user-engagement detection in some circumstances. Consider, for example, collecting sentiment information about a comedy program. An embodiment of the invention may be implemented as a “Laugh” user-interface button, which the user is to press when he finds the program amusing. The button increases a “funny” rating estimate, which is sampled periodically during the program to produce the real-time sentiment indication at that time, and which is decreased automatically so that the real-time sentiment indicator is roughly inversely proportional to the time since the last gag or bit that the viewer found amusing. (As with the automatically-returning-to-zero slider, an incrementing/decrementing rating estimate would be limited to a lower bound, so that an extended period of flat jokes would not obscure renewed viewer interest later in the program.) Along these lines, a plurality of user interface buttons may be provided, so that the viewer can report various sentiments, such as amusement, interest, surprise, disgust and so on. Each button would increment or increase a corresponding counter, and all counters would be decremented or diminished automatically so that they return to a neutral indication.

Other user-engagement mechanisms may take a more passive approach: instead of automatically decaying to some neutral value, the embodiment may display a reminder (e.g., as a note overlaid on the media program display) to provide feedback when there has been no change in the rating control setting for longer than a configurable period of time.

It is appreciated that the user sentiment interface controls may themselves provide feedback to the user when they are activated. For example, a “Laugh” button may insert a short burst of laughter (a “laugh track”) into the audio of the program. A control setting indicating a sharp increase in viewer antipathy might provide a “sad trombone” audio feedback. Such feedback may also be emitted in response to sentiment indications from other viewers—that is, the laugh track may play when the average sentiment reported by others increases sharply or exceeds a predetermined level.

As explained earlier, an embodiment of the invention may be implemented in a distributed computing environment, where various parts of the media program to be analyzed are delivered to the viewer from different sources. In such an environment, a preferred embodiment of the invention may be implemented as a media player to be embedded in a web browser, providing ordinary audio and video reproduction functions, and also the viewer-sentiment interface controls to collect the periodic sentiment estimations and report them to a recording and analysis server for further processing. An alternative embodiment may provide just the sentiment-collection controls in a thin “wrapper” around a conventional media player (the media player appears as an “embedded” sub-component of the inventive information-collecting interface). In either arrangement, the user-sentiment collection means is coupled to the playback means in a way that permits the periodic readings of sentiment indication to be synchronized with particular temporal portions of the media program. For example, sentiment readings may be timestamped with the elapsed time of the program, a video frame counter, or some similar indicator.

FIG. 3B shows a sample display that presents previously-collected sentiment information. A window 330 displays the media program 335, with one or more sentiment graphs superimposed. In this display, graph line 340 represents the current viewer's sentiment indications, while graph line 345 represents an aggregated value comprising other viewers' indications. The display may dynamically show the changing sentiment indications by, for example, moving a time-indicating cursor across the screen, with past sentiments shown with a first color, opacity or other visual attribute, and upcoming sentiment readings shown in a second color, opacity or visual attribute. In FIG. 3B, sentiment lines to the left of the time cursor at 350 are solid, while lines 355 representing “upcoming” sentiment values are dashed. An embodiment may also produce a graph 360 showing only sentiment values, rather than superimposing the graph over the media program. Graphs like the ones shown in this Figure allow comparison between the sentiment indicators of one viewer (or a first group of viewers) and a second viewer (or a second group of viewers). This may be useful to identify groups who particularly like or dislike aspects of a program; the information can help improve either future versions of the program itself, or marketing efforts to bring the program to the attention of viewers who may be especially receptive.

Although the foregoing discussion chiefly addresses the use of an embodiment to collect rating information about a recorded program, it is appreciated that embodiments can also collect feedback from viewers of a live media event. Of course, there will be no “historical” data from other viewers to compare against, but real-time data collected from other users who are also watching the program live can be aggregated and presented to the other viewers (i.e., each viewer can see his instantaneous and historical sentiment indication, and near-instantaneous and historical aggregate sentiment from some or all of the other viewers). In addition, an embodiment records the data (with timing information so that it can be correlated with a recorded version of the media program) and can display or report on the data later, for viewers who watch the recorded program afterward, and/or for review by the program's performers.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that audience response measurements can also be produced by software and hardware that distribute the functions of embodiments of this invention differently than herein described. Such variations and implementations are understood to be captured according to the following claims.

I claim:

1. A method comprising:
commencing reproduction of an entertainment program;
at intervals during the reproduction, receiving sentiment indications from a viewer of the entertainment program to form a plurality of sentiment indications; and
recording the plurality of sentiment indications.

2. The method of claim 1, further comprising:
constructing a composite sentiment indicator set from recorded sentiment indications of a plurality of other viewers; and
displaying a comparison graph between the plurality of sentiment indicators from the viewer and the composite sentiment indicator set.

3. The method of claim 2 wherein constructing the composite sentiment indicator set is calculating an average of the recorded sentiment indications of the plurality of other viewers.

4. The method of claim 1, further comprising:
collecting demographic information from the viewer before commencing reproduction; and
recording the demographic information with the plurality of sentiment indications.

5. The method of claim 1, further comprising:
identifying a second, different viewer whose recorded sentiment indications were similar to the plurality of sentiment indications; and
offering a second entertainment program to the viewer, where the second viewer's recorded sentiment indications about the second entertainment program were favorable.

6. The method of claim 1, wherein receiving sentiment indications comprises:
displaying a user-operable sliding control on a video monitor adjacent the reproduction of the entertainment program; and
reading a position of the sliding control.

7. The method of claim 1, wherein receiving sentiment indications comprises:
maintaining a numerically-valued sentiment indicator whose value automatically decays over time toward a neutral level;
adjusting the sentiment indicator in response to a signal from the viewer; and
registering the value of the sentiment indicator at the intervals.

8. A system comprising:
a media player to reproduce at least one of audio data and video data;
viewer-sentiment indicating means for obtaining an instantaneous indication of viewer sentiment during reproduction of the at least one of audio data and video data; and
a data recorder to store the instantaneous indication of viewer sentiment with a timestamp to correlate the instantaneous indication of viewer sentiment with a portion of the at least one of audio data and video data.

9. The system of claim 8 wherein the viewer-sentiment indicating means is a slider control displayed near the media player.

10. The system of claim 9 wherein an orientation of the slider control is horizontal.

11. The system of claim 9 wherein an orientation of the slider control is vertical.

12. The system of claim 8 wherein the viewer-sentiment indicating means is a button control displayed near the media player.

13. The system of claim 8 wherein the viewer-sentiment indicating means is a physical control operable by the viewer.

14. The system of claim 13 wherein the physical control is a rotating knob.

15. The system of claim 13 wherein the physical control is a scroll wheel of a mouse.

16. The system of claim 8, further comprising:
means for increasing user engagement.

17. The system of claim 16 wherein the means for increasing user engagement is an automatic return-to-neutral feature of the viewer-sentiment indicating means.

18. The system of claim 16 wherein the means for increasing user engagement is a viewer reminder displayed near the media player.

19. A computer-readable medium containing instructions and data to direct a programmable processor to perform operations comprising:
receiving media program information comprising audio and video data;
displaying the audio and video data on a monitor and speakers of a computer;
displaying a user-sentiment feedback control near the video data on the monitor;
sampling a position of the user-sentiment feedback control at a plurality of times during the displaying operation to produce a plurality of sentiment samples;
timestamping each of the plurality of sentiment samples with information to associate the sentiment sample with a corresponding playback time; and
transmitting the timestamped sentiment samples to a remote system for storage and analysis.

20. The computer-readable medium of claim 19, containing additional instructions and data to direct the programmable processor to perform operations comprising:
receiving a plurality of timestamped, aggregated, other-viewer sentiment samples from the remote system; and
displaying a comparison graph showing the plurality of sentiment samples and the plurality of other-viewer sentiment samples, said comparison graph overlaid on the video data.
